(19) United States
(12) Patent Application Publication
(10) Pub. No.: US 2025/0102069 A1
(43) Pub. Date: Mar. 27, 2025

(54) Pinch valve

(71) Applicant: Contour Biosolutions, LLC, Middlesex, NJ (US)

(72) Inventor: Louis Bongiorno, Millington, NJ (US)

(73) Assignee: Contour Biosolutions, LLC, Middlesex, NJ (US)

(21) Appl. No.: 18/894,336

(22) Filed: Sep. 24, 2024

Related U.S. Application Data
(60) Provisional application No. 63/585,245, filed on Sep. 26, 2023.

(51) Int. Cl. F16K 7/06

(52) U.S. Cl. CPC F16K 7/061

(57) ABSTRACT

A pinch valve comprises a first valve section, a second valve section, and a pinch mechanism. The first valve section includes a first fastener protrusion located at a first top wall first end and a first hinge protrusion located at a first top wall second end. The second valve section includes a recess in a bottom wall thereof, a second fastener protrusion located at a second bottom wall first end, and a second hinge protrusion located at a second bottom wall second end. The pinch mechanism includes a pinch member and a threaded rod. The threaded rod is configured to advance and retract the pinch member by threading the threaded rod into and out of the threaded hole with a top surface of the pinch member configured to retract into the recess as the threaded rod retracts the pinch member.

### CROSS REFERENCES AND PRIORITIES

This application claims priority from U.S. Provisional Application No. 63/585,245 filed on 26 Sep. 2023, the teachings of which are incorporated by reference herein in their entirety.

### BACKGROUND

Pinch valves are used in a variety of applications including chemical manufacturing processes and equipment. The standard operation of a pinch valve involves a section of elastic tubing (hose or sleeve) and a device which directly contacts the body of the elastic tubing. The device includes a component that can be advanced and retracted. As that component is advanced, the inner walls of the elastic tubing are brought together in such a manner that a seal is created within the flow path of liquid flowing through the tubing thereby stopping the flow of said liquid.

Existing pinch valves suffer from several flaws. Specifically, the existing pinch valves are assembled by a series of bolts or screws on either side of the device which require significant manual labor to disassemble and move. This is particularly problematic in applications such as single-use chemical processing equipment. Single-use chemical processing equipment—in which the various components are typically manufactured of a polymer material as opposed to metals found in reusable processing equipment-conduct the entire duration of the chemical production process in a single batch utilizing processing equipment that is transported off-site for sterilization using gamma, EtO, or x-ray sterilization methods. These methods provide greater assurance of sterility at a lower cost than steam sterilizing multi-use metal systems. The requirement of replacing the entire process assembly creates a need for products that assemble quickly and accurately.

Additionally, existing pinch valves are often sized and shaped for use with a specific diameter of elastic tubing. As the size of elastic tubing can vary throughout the chemical processing system, these differences often call for the assembler to stock a variety of pinch valves for different sizes of elastic tubing. This can significantly slow the process of assembling the chemical processing system as the assembler identifies the correct size pinch valve for application to each individual section of elastic tubing. Worse, if the incorrect size pinch valve is identified, the pinch valve may be rendered inoperable as it is unable to fit around the specific section of elastic tubing and/or unable to apply sufficient pressure to the section of elastic tubing to stop the flow of fluid.

The need exists, therefore, for an improved pinch valve which is quicker and easier to assemble and may be used in conjunction with a variety of different sizes of elastic tubing.

### SUMMARY

Described herein is a pinch valve. The pinch valve comprises a first valve section, a second valve section and a pinch mechanism.

The first valve section has a bottom wall and a first top wall opposite the first bottom wall. The first top wall comprises a groove, a first fastener protrusion located at a first top wall first end, and a first hinge protrusion located at a first top wall second end.

The second valve section has a second bottom wall and a second top wall opposite the second bottom wall. The second bottom wall comprises a recess, a second fastener protrusion located at a second bottom wall first end, and a second hinge protrusion located at a second bottom wall second end. The second top wall comprises a threaded hole passing from the second top wall through the recess.

The pinch mechanism comprises a pinch member and a threaded rod. The pinch member has a bottom surface and a top surface.

The first valve section is configured to connect to the second valve section by mating the first hinge protrusion to the second hinge protrusion and mating the first fastener protrusion to the second fastener protrusion. The bottom surface of the pinch member is sized and shaped to mate to the groove. The threaded rod is configured to advance and retract the pinch member by threading the threaded rod into and out of the threaded hole. The top surface of the pinch member is configured to retract into the recess as the threaded rod retracts the pinch member.

In some embodiments, a recess depth dimension of the recess of the second bottom wall may be at least 50% of a pinch member height dimension of the pinch member such that at least 50% of the pinch member retracts into the recess when the pinch mechanism is in a fully retracted position.

In certain embodiments, the first hinge protrusion may include a pair of opposing cylindrical protrusion. In such embodiments, the second hinge protrusion may include a pair of opposing cradles. Each opposing cylindrical protrusion may be configured to pivotably connect to one of the opposing cradles.

In some embodiments, the first fastener protrusion may include an extension having a lip at a distal end thereof. In such embodiments, the second fastener protrusion may include a hole passing through the second fastener protrusion. The lip may be configured to engage at least a portion of a top edge of said hole.

In certain embodiments, the groove may have a groove shape selected from the group consisting of substantially arched and substantially polygonal. In some embodiments, the pinch member hay have a shape selected from the group consisting of substantially circular and substantially polygonal. In certain embodiments, the threaded rod may include a knob attached to an end opposite the pinch member.

### BRIEF DESCRIPTION OF FIGURES

FIG. 1 is an exploded perspective view of a pinch valve.

FIG. 2 is a partially assembled perspective view of a pinch valve.

FIG. 3 is a partially assembled side view of a pinch valve.

FIG. 4 is an assembled perspective view of a pinch valve.

FIG. 5 is a side view of a pinch valve with a retracted pinch member.

FIG. 6 is a side view of a pinch valve with an extended pinch member.

FIG. 7 is an axial cross section of a pinch valve.

FIG. 8 is a perspective view of a pinch valve in an opened position holding a section of hose.

FIG. 9 is a perspective view of a pinch valve in a closed position holding a section of hose.

### DETAILED DESCRIPTION

Disclosed herein is a pinch valve. The pinch valve is described below with reference to the Figures. As described herein, the following numbers refer to the following structures as noted in the Figures.
10 refers to a pinch valve.
100 refers to a first valve section.
110 refers to a first bottom wall.
120 refers to a first top wall.
121 refers to a groove.
122 refers to a first fastener protrusion.
123 refers to a first top wall first end.
124 refers to a first hinge protrusion.
125 refers to a first top wall second end.
130 refers to a cylindrical protrusion.
140 refers to an extension.
141 refers to a lip.
142 refers to a distal end.
200 refers to a second valve section.
210 refers to a second bottom wall.
211 refers to a recess.
212 refers to a second fastener protrusion.
213 refers to a second bottom wall first end.
214 refers to a second hinge protrusion.
215 refers to a bottom wall second end.
216 refers to a recess depth dimension.
220 refers to a second top wall.
221 refers to a threaded hole.
230 refers to a cradle.
240 refers to a hole.
241 refers to a top end.
300 refers to a pinch mechanism.
310 refers to a pinch member.
311 refers to a bottom surface.
312 refers to a top surface.
313 refers to a pinch member height dimension.
320 refers to a threaded rod.
321 refers to a knob.
400 refers to a tubing section.

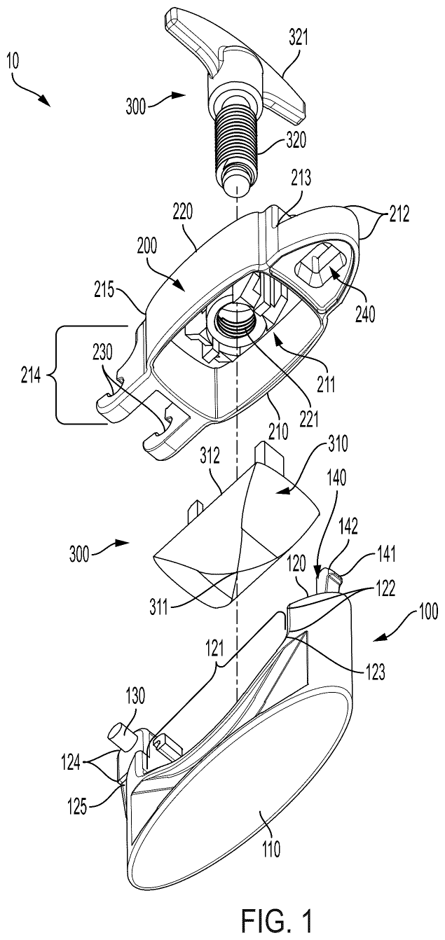

FIG. 1 shows an exploded perspective view of a pinch valve (10). The pinch valve comprises a first valve section (100), a second valve section (200), and a pinch mechanism (300).

As shown in FIG. 1, the first valve section (100) includes a first bottom wall (110) and a first top wall (120) opposite the first bottom wall. The size, shape, and configuration of the first bottom wall is not considered important. In general, the first bottom wall may include or consist of a substantially flat or flat surface.

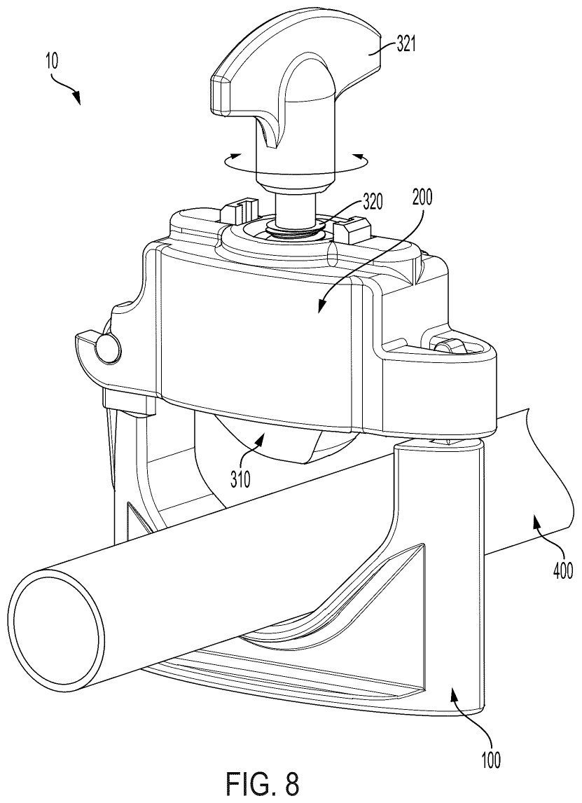

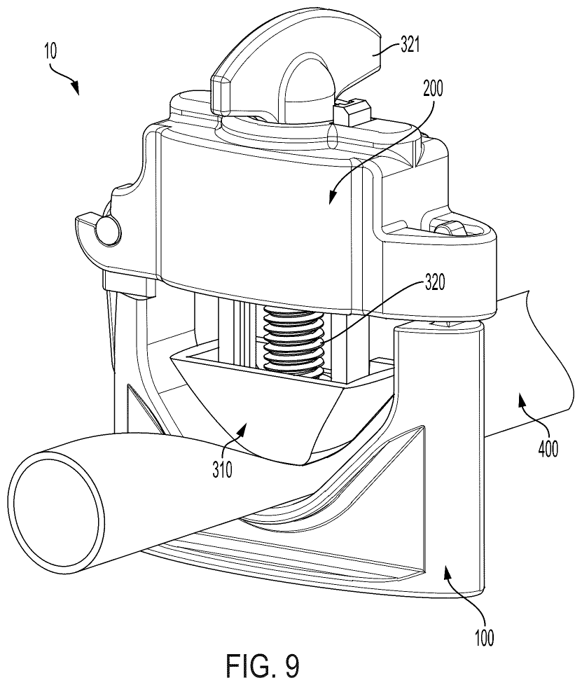

The first top wall (120) includes a groove (121) within which a tubing section ((400) as shown in FIG. 8 and FIG. 9) may be disposed when the pinch valve (10) is in use. The size and shape of the groove may depend upon a number of factors including the size and configuration of the tubing section for which the pinch valve is intended to be used. In general, the groove may have a groove shape which is substantially arched or substantially polygonal.

The first valve section (100) may also include a first fastener protrusion (122) which is located at a first top wall first end (123). Further, the first valve section may include a first hinge protrusion (124) located at a first top wall second end (125) which is opposite the first top wall first end. When the pinch valve (10) is assembled, the first fastener protrusion and the first hinge protrusion may be utilized to connect the first valve section to the second valve section (200) as described herein.

As shown in FIG. 1, the second valve section (200) includes a second bottom wall (210) and a second top wall (220) opposite the second bottom wall. The size, shape, and configuration of the second top wall is not considered important. In general, the second top wall may include or consist of a substantially flat or flat surface.

The second bottom wall (210) includes a recess (211) therein which extends in the direction of the second top wall (220) without passing through the second top wall. The size and shape of the recess may depend upon a number of factors including the size and shape of a pinch member (310) of the pinch mechanism (300) which is to be partially or fully disposed within the recess when the pinch member is in a partially or fully retracted position as described herein.

The second valve section (200) may also include a second fastener protrusion (212) which is located at a second bottom wall first end (213). Further, the second valve section may include a second hinge protrusion (214) located at a second bottom wall second end (215) which is opposite the second bottom wall first end. When the pinch valve (10) is assembled, the second fastener protrusion and the second hinge protrusion may be utilized to connect the second valve section to the first valve section (100) as described herein.

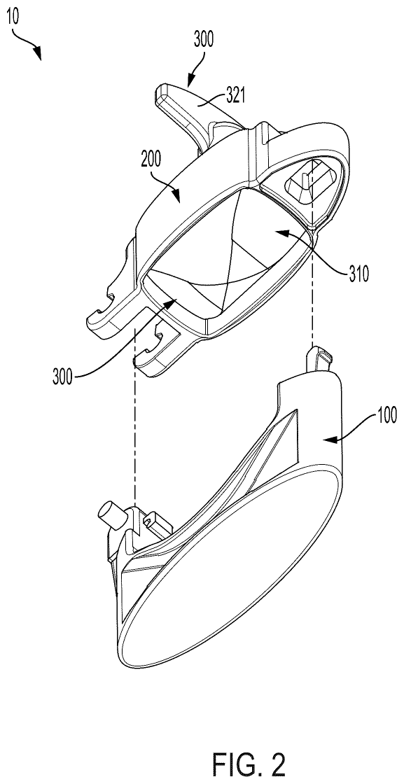

As shown in FIG. 1, the pinch mechanism (300) includes a pinch member (310) and a threaded rod (320). The pinch member has a bottom surface (311) and a top surface (312). The threaded rod is configured to advance and retract the pinch member by threading the threaded rod into and out of a threaded hole (221) which passes from the second top wall (220) through the recess (211) as shown in FIG. 2 in which the pinch mechanism is shown assembled with the second valve section (200).

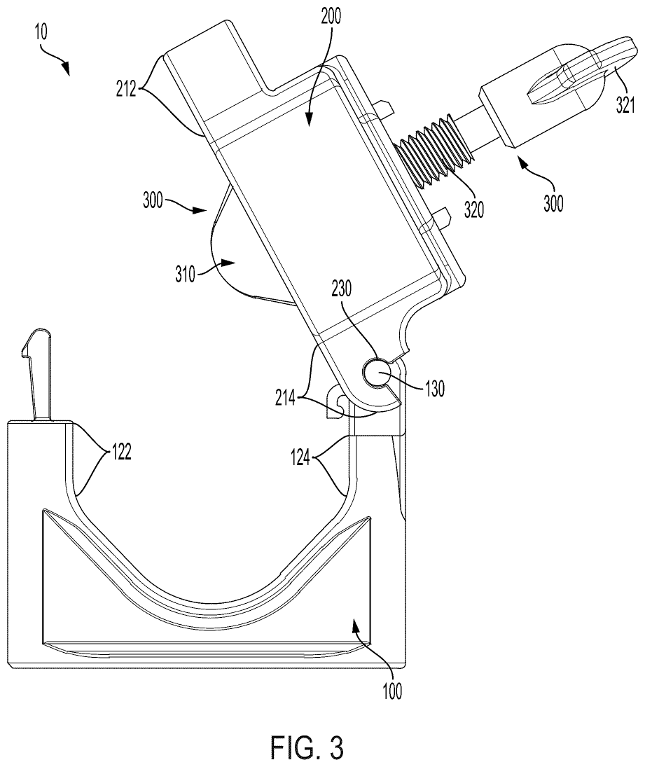

FIG. 3 shows the pinch mechanism (300) assembled with the second valve section (200) and the second valve section partially assembled with the first valve section (100) with the hinge protrusion sides of the two valve sections connected to one another. As shown in FIG. 3, the first hinge protrusion (124) may include a pair of opposing cylindrical protrusions (130) while the second hinge protrusion (214) may include a pair of opposing cradles (230). Each opposing cylindrical protrusion is configured to pivotably connect to one of the opposing cradles, creating a hinged connection between the first valve section and the second valve section. Preferably, the pair of opposing cradles will be configured in such a manner that they create a friction fit or snap fit with the respective cylindrical protrusions that impairs the ability of the first hinge protrusion to unintentionally disconnect from the second hinge protrusion.

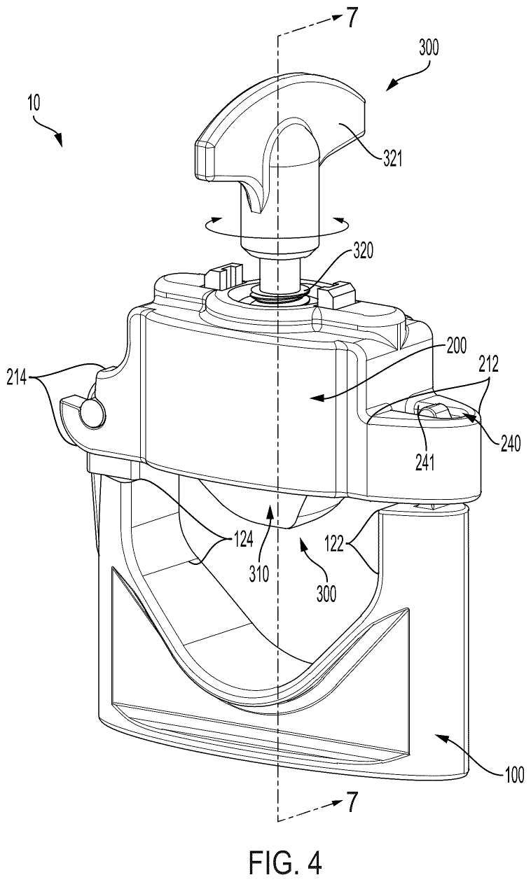

FIG. 4 shows the pinch mechanism (300) assembled with the second valve section (200), and the pinch valve (10) fully assembled with the hinge protrusion sides of the two valve sections connected to one another and the fastener protrusion sides of the two valve sections connected to one another. As shown in FIGS. 1 and 4, the first fastener protrusion (122) may include an extension (140) having a lip (141) at a distal end (142) thereof. The second fastener protrusion (212) may include a hole (240) passing through the second fastener protrusion. The extension is configured to pass into and partially through the hole with the lip configured to frictionally engage at least a portion of the top edge (241) of the hole. In conjunction with the connection between the hinge protrusion sides of the two valve sections described herein, the connection between the fastener protrusion sides of the two valve sections securely attach the first valve section (100) and the second valve section.

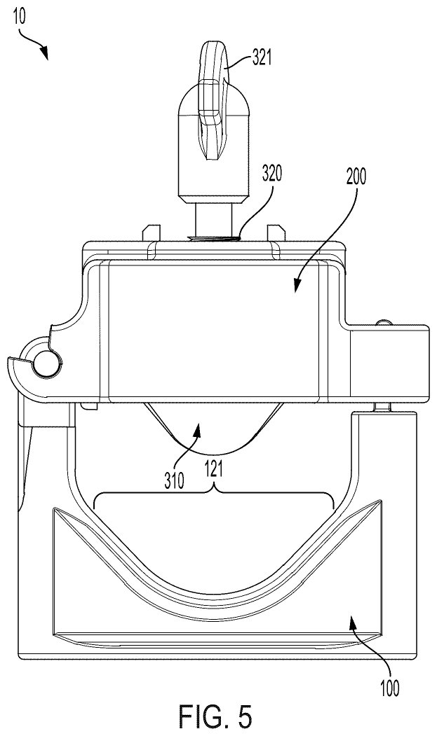

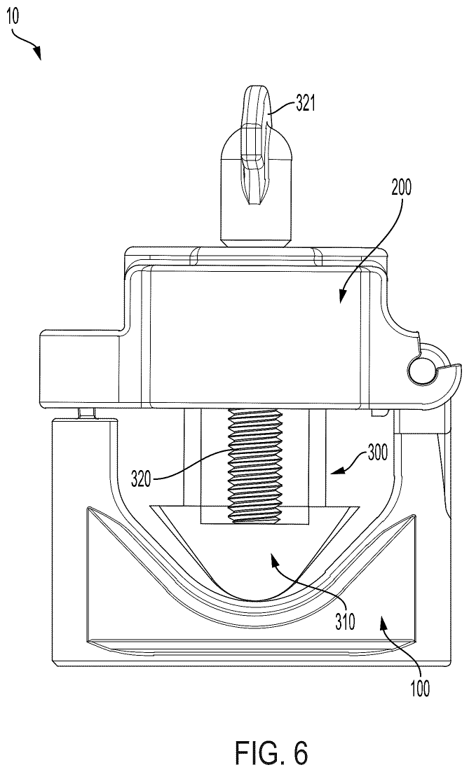

FIG. 5 and FIG. 6 show the advancement of the pinch mechanism (300) towards the groove (121). Specifically, FIG. 5 shows the pinch mechanism in a partially or fully retracted position. In this position, the threaded rod (320) is threaded partially out of the threaded hole ((221) as shown in FIG. 1). As the threaded rod is connected to the top surface (312) of the pinch member (310), partially threading the threaded rod out of the threaded hole retracts the pinch member into the recess ((211) as shown in FIG. 1). The threaded rod is preferably connected to the top surface of the pinch member by a friction fit or snap fit which allows the bottom end of the threaded rod to rotate about the top surface of the pinch member without also rotating the pinch member itself. In some embodiments, the threaded rod may include a knob (321) attached to an end opposite the pinch member which allows an operator to easily thread the threaded rod into and out of the threaded hole.

FIG. 6 shows the pinch mechanism (300) in a partially or fully extended position. In this position, the threaded rod (320) is threaded partially into the threaded hole (221 as shown in FIG. 1). As the threaded rod is connected to the top surface (312) of the pinch member (310), partially threading the threaded rod into the threaded hole advances the pinch member out of the recess (211 as shown in FIG. 1) and towards the groove (121).

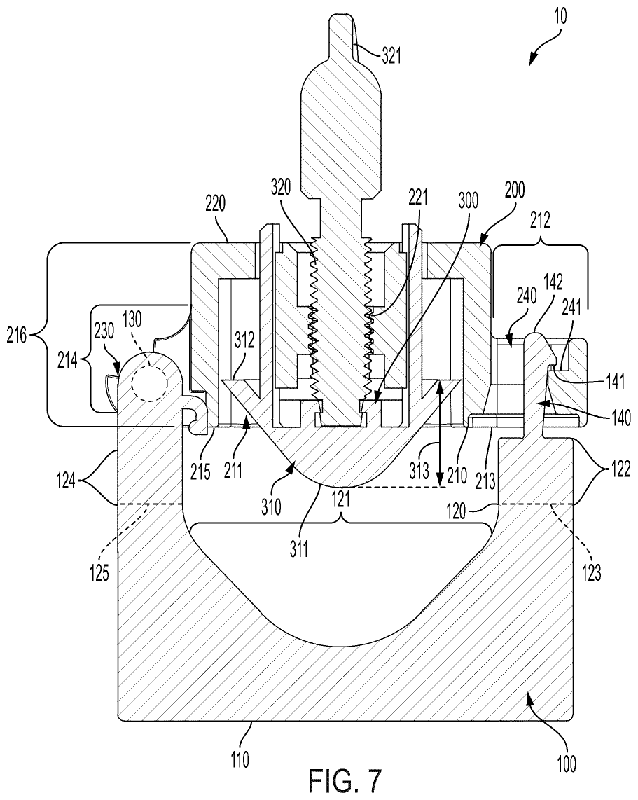

FIG. 7 shows the pinch valve (10) in axial cross section with the pinch mechanism (300) in a fully retracted position. As shown in FIG. 7, the pinch member (310) has a pinch member height dimension (313). When the pinch mechanism is in a fully retracted position, at least 20% of the pinch member height dimension may retract into the recess (211) as shown in FIG. 7 with at least 35% of the pinch member height dimension retracting into the recess being more preferred and at least 50% of the pinch member height dimension retracting into the recess being most preferred. To do so, a recess depth dimension (216) will preferably be at least 20% of the pinch member height dimension with at least 35% being more preferred and at least 50% being most preferred.

FIG. 8 and FIG. 9 show the pinch valve (10) in use to open or close the flow of a fluid through a tubing section (400). As shown in FIG. 8, when the pinch mechanism (300) is in a partially or fully retracted position, the pinch member (310) fully or partially disengages from the tubing section, thereby opening the interior of the tubing section to allow the flow of a fluid through the tubing section. As the pinch mechanism is advanced towards the groove ((121) as shown in FIG. 6), the pinch member engages with the tubing section, thereby closing the interior of the tubing section and preventing the flow of a fluid through the tubing section.

The components of the pinch valve disclosed herein-including the first valve section (100), the second valve section (200), and the components of the pinch mechanism (300)—may be fabricated of any number of materials utilizing any number of manufacturing techniques. Non-limiting examples of such materials include polymer materials such as polypropylene, polyethylene, and polyvinylidene fluoride. Non-limiting examples of such manufacturing techniques include injection molding and additive manufacturing (commonly referred to as 3D printing).

The pinch valves described herein, with their hinged connection at one side, can be quickly assembled and disassembled about a section of elastic tubing (hose or sleeve) when compared to existing pinch valves. In addition, the recess in the pinch valves described herein allows for a wider range of motion for the pinch member such that the pinch valves described herein can be used with a variety of different elastic tubing sections having varying sizes.

While the pinch valve has been described as having one or more exemplary designs, the present pinch valve may be further modified within the spirit and scope of this disclosure. This application is therefore intended to cover any variations, uses, or adaptations of the pinch valve using its general principles.

What is claimed is:

1. A pinch valve (10) comprising:
a first valve section (100) having a first bottom wall (110), and a first top wall (120) opposite the first bottom wall, said first top wall comprising a groove (121), a first fastener protrusion (122) located at a first top wall first end (123), and a first hinge protrusion (124) located at a first top wall second end (125);
a second valve section (200) having a second bottom wall (210), and a second top wall (220) opposite the second bottom wall, said second bottom wall comprising a recess (211), a second fastener protrusion (212) located at a second bottom wall first end (213), and a second hinge protrusion (214) located at a second bottom wall second end (215), and said second top wall comprising a threaded hole (221) passing from the second top wall through the recess; and
a pinch mechanism (300) comprising a pinch member (310), and a threaded rod (320), said pinch member having a bottom surface (311) and a top surface (312); and
wherein the first valve section is configured to connect to the second valve section by mating the first hinge protrusion to the second hinge protrusion and mating the first fastener protrusion to the second fastener protrusion; the bottom surface of the pinch member is sized and shaped to mate to the groove; the threaded rod is configured to advance and retract the pinch member by threading the threaded rod into and out of the threaded hole; and the top surface of the pinch member is configured to retract into the recess as the threaded rod retracts the pinch member.

2. The pinch valve of claim 1, wherein a recess depth dimension (216) is at least 50% of a pinch member height dimension (313) such that at least 50% of the pinch member retracts into the recess when the pinch mechanism is in a fully retracted position.

3. The pinch valve of claim 1, wherein the first hinge protrusion includes a pair of opposing cylindrical protrusion (130), the second hinge protrusion includes a pair of opposing cradles (230), and each opposing cylindrical protrusion is configured to pivotably connect to one of the opposing cradles.

4. The pinch valve of claim 1, wherein the first fastener protrusion includes an extension (140) having a lip (141) at a distal end (142) thereof, the second fastener protrusion includes a hole (240) passing through the second fastener protrusion, and the lip is configured to engage at least a portion of a top edge (241) of the hole.

5. The pinch valve of claim 1, wherein the groove has a groove shape selected from the group consisting of substantially arched and substantially polygonal.

6. The pinch valve of claim 1, wherein the pinch member has a shape selected from the group consisting of substantially circular and substantially polygonal.

7. The pinch valve of claim 1, wherein the threaded rod includes a knob (321) attached to an end opposite the pinch member.

8. The pinch valve of claim 2, wherein the first hinge protrusion includes a pair of opposing cylindrical protrusion, the second hinge protrusion includes a pair of opposing cradles, and each opposing cylindrical protrusion is configured to pivotably connect to one of the opposing cradles.

9. The pinch valve of claim 2, wherein the first fastener protrusion includes an extension having a lip at a distal end thereof, the second fastener protrusion includes a hole passing through the second fastener protrusion, and the lip is configured to engage at least a portion of a top edge of the hole.

10. The pinch valve of claim 2, wherein the groove has a groove shape selected from the group consisting of substantially arched and substantially polygonal.

11. The pinch valve of claim 2, wherein the pinch member has a shape selected from the group consisting of substantially circular and substantially polygonal.

12. The pinch valve of claim 2, wherein the threaded rod includes a knob attached to an end opposite the pinch member.

13. The pinch member of claim 3, wherein the first fastener protrusion includes an extension having a lip at a distal end thereof, the second fastener protrusion includes a hole passing through the second fastener protrusion, and the lip is configured to engage at least a portion of a top edge of the hole.

14. The pinch member of claim 3, wherein the groove has a groove shape selected from the group consisting of substantially arched and substantially polygonal.

15. The pinch member of claim 3, wherein the pinch member has a shape selected from the group consisting of substantially circular and substantially polygonal.

16. The pinch member of claim 3, wherein the threaded rod includes a knob attached to an end opposite the pinch member.

17. The pinch member of claim 5, wherein the pinch member has a shape selected from the group consisting of substantially circular and substantially polygonal.

18. The pinch member of claim 13, wherein the groove has a groove shape selected from the group consisting of substantially arched and substantially polygonal.

19. The pinch member of claim 13, wherein the pinch member has a shape selected from the group consisting of substantially circular and substantially polygonal.

20. The pinch member of claim 13, wherein the threaded rod includes a knob attached to an end opposite the pinch member.
